(19) United States
(12) Patent Application Publication
(10) Pub. No.: US 2026/0347217 A1
(43) Pub. Date: Nov. 5, 2026

(54) METHOD AND SYSTEM FOR REMOVAL OF TARGET MOLECULES FROM WATER BY FOAM FRACTIONATION

(71) Applicant: SANEXEN ENVIRONMENTAL SERVICES INC., Brossard (CA)

(72) Inventors: Étienne BÉLISLE-ROY, Otterburn Park (CA); Jean-François LAROSE, Lévis (CA); Éric LEBLANC, Montréal (CA); Yassir JADANI, Brossard (CA); Gilles GAGNON, Repentigny (CA); Martin BUREAU, Saint-Denis-de-Brompton (CA)

(21) Appl. No.: 19/118,183

(22) PCT Filed: Aug. 29, 2024
(86) PCT No.: PCT/CA2024/051121

§ 371 Date: Apr. 3, 2025

Related U.S. Application Data
(60) Provisional application No. 63/535,694, filed on Aug. 31, 2023.

(51) Int. Cl. C02F 1/24; C02F 1/36; C02F 1/461

(52) U.S. Cl. CPC C02F 1/24; C02F 1/36; C02F 1/46109; C02F 2201/007; C02F 2209/44; C02F 2301/046

(57) ABSTRACT

A foam fractionation method and a foam fractionation system for treating water contaminated, in recirculation loops of opposite flow directions connecting compartments of reactors operating simultaneously as air and water are circulated, producing target molecules-charged foam through water columns in each compartments, separating the produced foam as the air continues in the air recirculation loop and water continues in the water recirculation loop while target molecules-concentrate and treated water are separately evacuated from the water recirculation loop.

### FIELD OF THE INVENTION

The present invention relates to contamination in water. More specifically, the present invention is concerned with a method for removing of target molecules from water.

### BACKGROUND OF THE INVENTION

Contamination with molecules such as per and polyfluoroalkyl substances (PFAS) for instance is a growing environmental concern, for example on military bases, airport grounds, environmental sites such as landfills and water treatment plants, industrial sites, municipalities, and water networks. PFAS have been used for decades in a range of industrial applications and consumer products. Sometimes referred to as forever chemicals, PFAS spread widely in the environment, are bioaccumulative and persistent; very stable; they resist biodegradation once exposed to air, water or sunlight.

PFAS include aliphatic compounds, completely (perfluoroalkylated substances) or partially (polyfluoroalkylated substances) fluorinated, as well as more complex molecules (precursors). Some PFAS are extremely soluble in water; chemically stable due to a strong C-F bond, and non-volatile, with a vapor pressure close to zero.

PFAS disperse throughout the planetary ecosystems mainly by water circulation. As a result of their mobility and persistence, they may be found everywhere in the environment, including fauna, flora, and human population. Human exposure results from exposure to PFAS present in food, air, house dust, a range of consumer products such as textiles and kitchen utensils for example, as well as in drinking water. PFAS can be detected in the majority of the general population's blood (serum), breast milk and/or umbilical cord blood for instance.

Because PFAS have a surfactant-like behavior in water, they produce a foam when air is injected into water containing PFAS in sufficient concentration. Foam fractionation is used to separate matter that foam when air is injected into water, such as hydrophobic molecules, suspended particulates, dissolved organics, proteins, and tints for example, from a water solution, while also increasing dissolved oxygen levels, using rising reactors of foam, for example for the removal of organic waste from aquariums, in systems known as protein skimmers for example. The target molecules adsorb to bubble surfaces, and as the bubbles travel through a fractionation reactor to the surface of the water, they become denser and the formed foam drains from trapped water and becomes more concentrated with the target molecules, and these may be separated from the water.

In counter-current flow foam fractionation systems, water is sent from the top of a water reactor down through bubbles to create a counter-current stripping action for molecules removal, while ensuring mass mixing of air and water increasing skimmer efficiency. Typically, air and water are injected in the reactor and a riser cone on the top of the reactor collects foam with trapped molecules emerging at the surface of the water level within the reactor.

There is still a need in the art for a method and a system for removing of target molecules from contaminated water.

### SUMMARY OF THE INVENTION

More specifically, in accordance with the present invention, there is provided a foam fractionation system, comprising a raw water inlet; a treated water outlet; a concentrate outlet; air ducts configured into an air recirculation loop and a water recirculation loop, a flow direction in the air recirculation loop being opposite a flow direction in the water recirculation loop; and within the air and water recirculation loops: a water/air/foam separator; at least one fractionation reactor comprising at least two compartments located successively in the flow direction in the water recirculation loop from the first compartment of a first one of the at least one reactor in the water recirculation loop from the first reactor, each compartment comprising a top water/air/foam separator and bottom air diffusers; wherein, raw water containing target molecules entering the system through the raw water inlet of the system enters the water recirculation loop at an inlet of the first compartment, flows in the flow direction in the water recirculation loop through the successive compartments while the bottom air diffusers inject air in the water in each compartment individually, producing in a water column of each compartment air bubbles that attach the target molecules in the water column as the air bubbles ascend to a top water surface in each compartment and generate a target molecules-charged foam at the top water surface of each compartment, water separating from the target molecules-charged foam in the top water/air/foam separator of each compartment returning to the compartment while the target molecules-charged foam is drawn in the air recirculation loop to the water/air/foam separator; the water/air/foam separator separating water pumped out back to the first fractionation reactor, a target molecules concentrate pumped out of the water recirculation loop at a concentrate outlet of the water/air/foam separator to the concentrate outlet of the system, and air pumped to the bottom air diffusers; and water being pumped out of the water recirculation loop of the system at an outlet of a last compartment of the first reactor to the treated water outlet of the system.

There is further provided a foam fractionation method, comprising forming an air recirculation loop with an air flow direction, and a water recirculation loop with a water flow direction, the air flow direction being opposite the water flow direction; and, within the air and water recirculation loops: connecting a water/air/foam separator; and at least one fractionation reactor comprising at least two compartments located successively in the flow direction in the water recirculation loop from the first compartment of a first one of the at least one reactor in the water recirculation loop from the first reactor, each compartment comprising a top water/air/foam separator and bottom air diffusers; entering raw water into the water recirculation loop at a first compartment of a first reactor of the at least one fractionation reactor, injecting air of the air recirculation loop through the bottom air diffusers in a water column of each compartment individually, thereby producing in each compartment air bubbles that attach target molecules in the water column in each compartment as the air bubbles ascend to a top water surface in each compartment and generate a target molecules-charged foam at the top water surface of each compartment; in the top water/air/foam separator of each compartment: separating water from the target molecules-charged foam in the top water/air/foam separator of each compartment, for return by gravity in the compartment, from target molecules-charged foam, to be drawn to the water/air/foam separator by the air recirculation loop; at the water/air/foam separator: separating water pumped out back to the first fractionation reactor, from a target molecules concentrate pumped out of the water recirculation loop at a concentrate outlet of the water/air/foam separator, and from air pumped to the bottom air diffusers; and pumping treated water out of the water recirculation loop at an outlet of a last compartment of the first reactor.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematical view of a system according to an embodiment of an aspect of the present disclosure;

FIG. 2 is a schematical view of a fractionation reactor in the system of FIG. 1;

FIG. 3A is a schematical view of a flow straightener section according to an embodiment of an aspect of the present disclosure;

FIG. 3B is a schematical view showing flow straightener sections in the compartments R1-A1 to R1-A4 of the fractionation reactor R1 of FIG. 2 according to an embodiment of an aspect of the present disclosure;

FIG. 4A shows results of calculation of PFAS processing by a system according to an embodiment of an aspect of the present disclosure;

FIG. 4B show results of calculation of PFAS processing by a system according to an embodiment of an

### Aspect of the Present Disclosure;

FIG. 5 is a schematical view of a system according to an embodiment of an aspect of the present disclosure;

FIG. 6 is a schematical view of a fractionation reactor in the system of FIG. 5 according to an embodiment of an aspect of the present disclosure;

FIG. 7 is a schematical view showing a fractionation compartment of a fractionation reactor of FIG. 5 according to an embodiment of an aspect of the present disclosure;

FIG. 8 is a schematical top view of electrodes on the fractionation compartment of FIG. 7; and

FIG. 9 is a schematical view showing electrodes in a fractionation compartment of a fractionation reactor according to an embodiment of an aspect of the present disclosure.

### DESCRIPTION OF ILLUSTRATIVE EMBODIMENTS

The present invention is illustrated in further detail by the following non-limiting examples.

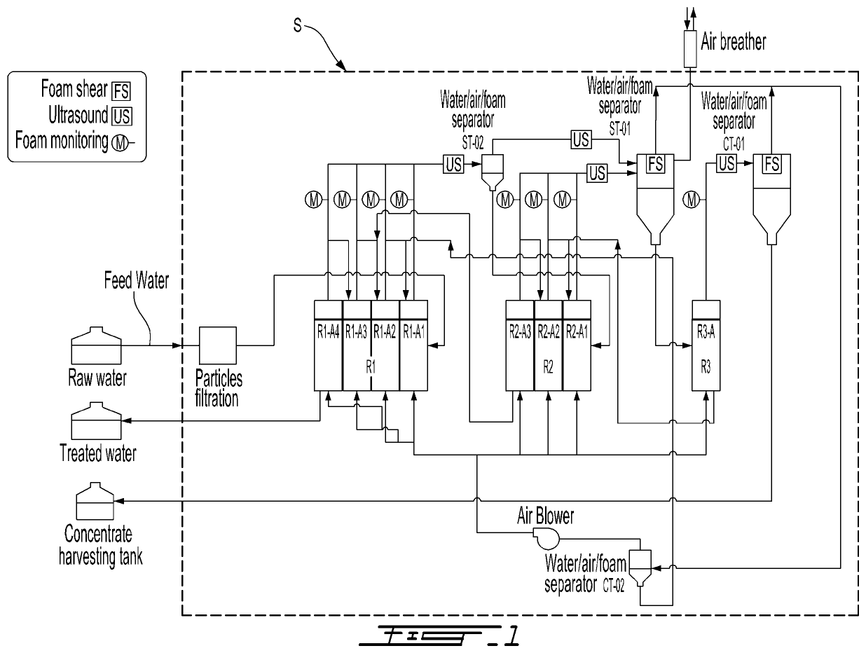

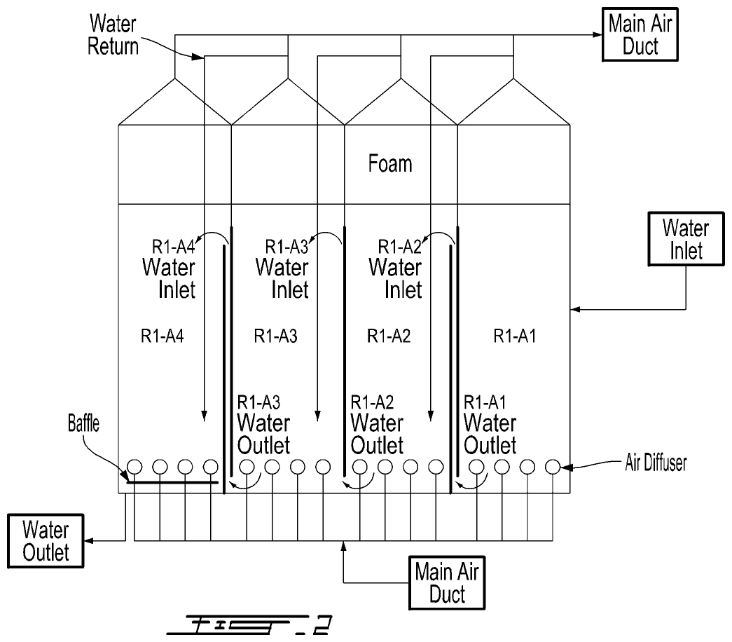

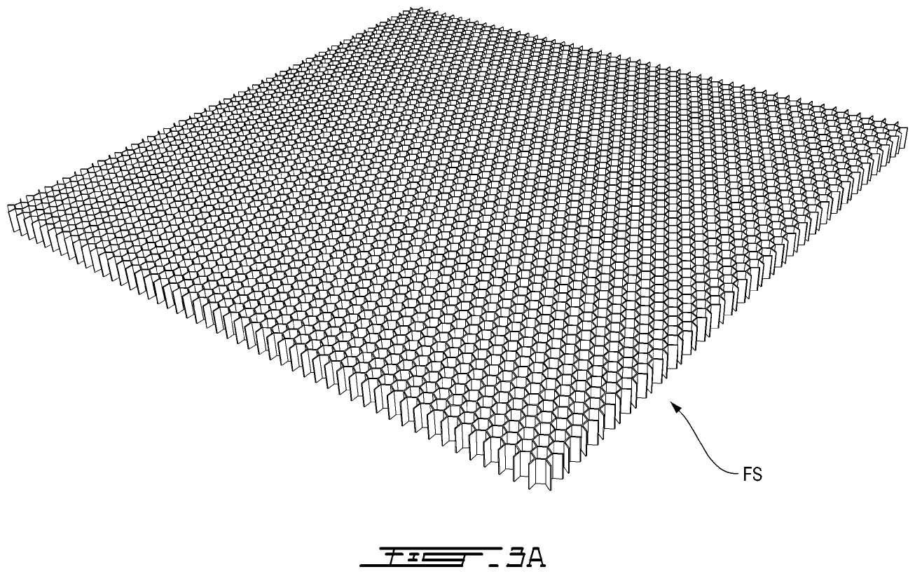

A system(S) according to an embodiment of an aspect of the present disclosure as illustrated in FIG. 1 for example with boundaries indicated by stippled lines, comprises fractionation reactors R1, R2, and R3 and water/air/foam separators ST-01, ST-02, CT-01 and CT-02, connected in an air recirculation loop and a water recirculation loop through respective ducts within the system as will be detailed hereinbelow.

The first reactor R1 comprises fractionation compartments R1-A1, R1-A2, R1-A3 and R1-A4 in water communication in the water recirculation loop from the water outlet of the first comportment R1-A1 to the water inlet of the second compartment R1-A2, and from the water outlet of the second compartment R1-A2 to the water inlet of the third compartment R1-A3 and from the water outlet of the third compartment R1-A3 to the water inlet of the fourth compartment R1-A4. Each one of the compartments is individually connected at a top thereof to the air recirculation loop via a respective water/air/foam separator (not shown).

The raw water entering and feeding the system S is water contaminated with molecules such as PFAs and other contaminants such as for example microbial electrochemical systems (MES), colloids, microplastics, hydrophobic/oleophilic molecules; it may be passed by a particles filtration media for solid particles filtration.

At start-up, the system contains ambient air and is empty of water. The target molecules-containing raw water is pumped into the water recirculation loop within the system through a water inlet of the system. Once the water ducts of the water recirculation loop within the system are full with the target molecules-containing raw water, the system hermetically air-closed and the feeding with raw water continuing, the air present in the system is recirculated in the air recirculation loop through air ducts thereof within the system, and treatment of the target molecules-containing raw water starts within the system as described hereinbelow, as the target molecules-containing raw water is still being pumped into the system now closed to air.

In operation, the target molecules-containing raw water is pumped through the water inlet of the system to the water inlet of the first compartment R1-A1 of the first reactor R1, water flows from the water outlet of the first compartment R1-A1 to the second compartment R1-A2 and from the second compartment R1-A2 to the third compartment R1-A3 and from the third compartment R1-A3 to the fourth compartment R1-A4, in cascade, while air is injected from the air recirculation loop by air diffusers, fed through the water/air/foam separator CT-02 that separates any remaining water and foam from air coming out from the water/air/foam separators ST-01 and CT-01 in the air recirculation loop, through the water in each compartment individually, producing air bubbles that attach target molecules on their way through the water in each compartment, and generate target molecules-charged foam of increasing target molecules concentration as they ascend in each compartment to the water surface and the respective top water/air/foam separator of each compartment individually connected to air recirculation loop, water separated from the foam in each water/air/foam separator being returned by gravity in the compartments, the air flow continuing in the air recirculation loop towards the second water/air/foam separator ST-01 as will be detailed hereinbelow.

Treated water is pumped from the water recirculation loop within the system out of the system at the water outlet of the fourth compartment R1-A4 of the first reactor R1.

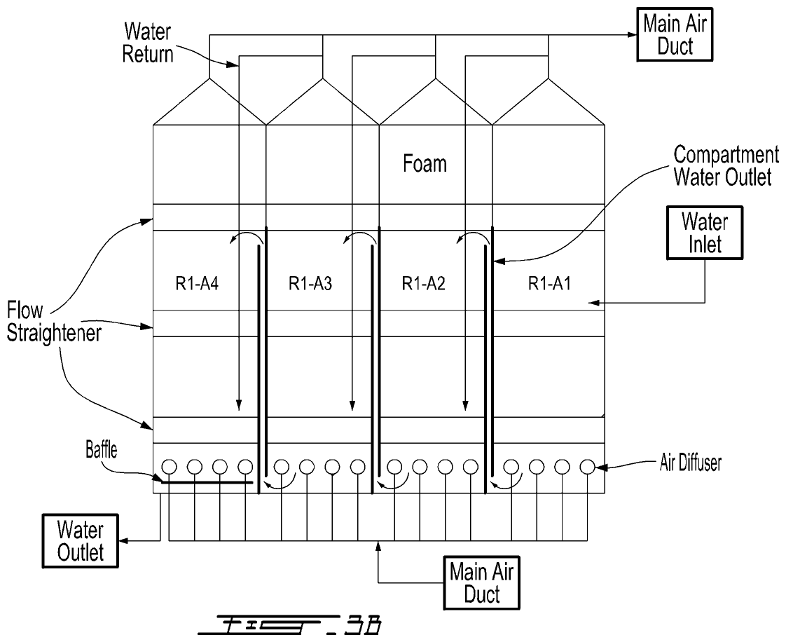

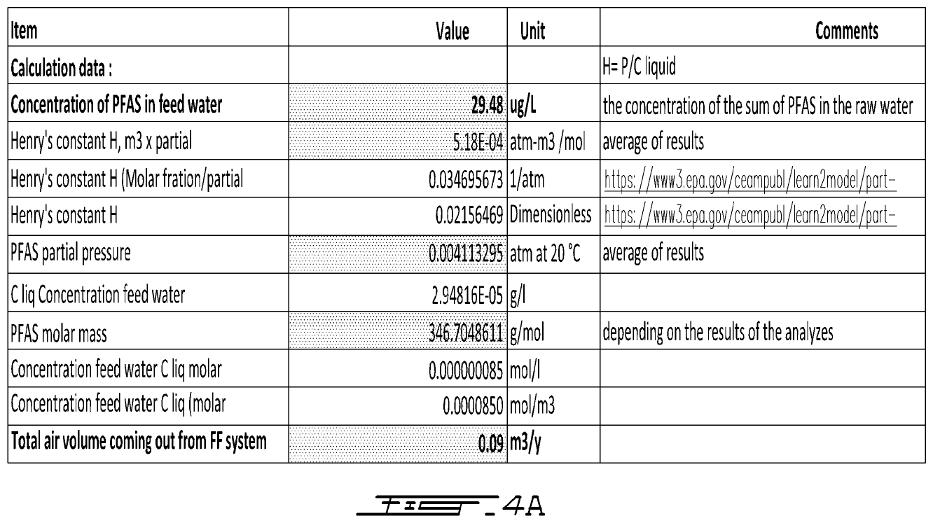

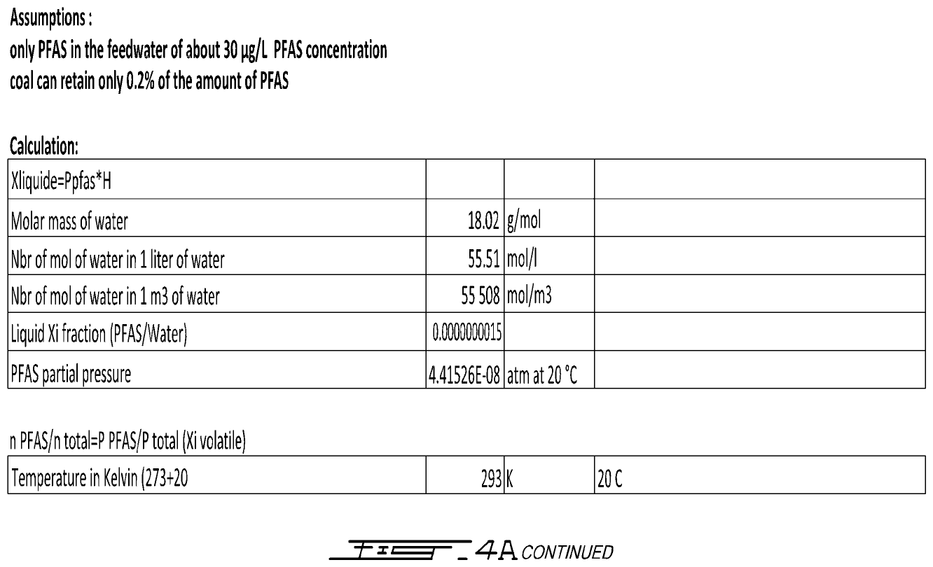

A baffle, such as a rectangular plate placed a few inches above the water outlet of the fourth compartment R1-A4, may be used for blocking air bubbles from being dragged in the treated water, as illustrated in FIG. 2.

The relative positions of the water inlets and water outlets and of the air diffusers in each compartment are selected to optimize the residence time of the water within each compartment as the water flows from the respective water inlet and outlet thereof, and minimize non-bubbled water trapped in the foam at the top of each compartment; the position of the air diffusers is selected according to the position of water inlet, water outlet and water column in the compartment, low enough in each compartment to maximize circulation of air through the water column in the compartment while not too low in each compartment to avoid generating bubbles that are charged with target molecules passing with the water flow from a compartment to the next. In the embodiment illustrated in FIG. 2, the water inlet is positioned at mid-height of each compartment and the compartment water outlet is positioned below the position of the air diffusers, in each compartment.

The target molecules-contamination of the water is thus treated in the water flow direction of the water recirculation loop from the first compartment to the fourth compartment. As foaming varies depending on the concentration of target-molecules in the water, less target molecules-concentrated water needing increased airflow rate for target foaming for example, separate regulation valves may be used for controlling the injection of air by the respective air diffusers of each compartment and adjust the air flow rate of injected air up each compartment.

In the drawings, reference characters R2-A3, R2-A2, R2-A1, and R3-A in FIG. 1; and R2-A in FIG. 5, refer to compartments of respective rectors R1, R2, and R3.

In the reactor R1, foam fractionation of water is thus performed separately and simultaneously in each compartment, in cascade, while water pumped out of the fourth compartment to the treated water outlet of the system, with an optional polishing filter depending on target treatment requirements, and while the airflow continues in the air recirculation loop toward the reactors R2, R3 and the water/air/foam separator CT-01.

The third reactor R3 receives water separated from the foam charge in the air recirculation loop by a corresponding water/air/foam separator ST-01 in the air recirculation loop, while foam fractionation is performed in the third reactor R3 in a same way as described hereinabove in relation to the first reactor R1, and foam produced in the third reactor R3 is flown to the water/air/foam separator CT-01, and water is pumped from the third reactor R3 out to foaming compartments of the second reactor R2 for foam fractionation in the second reactor R2 in a same way as described hereinabove in relation to the first reactor R1, while foam generated in the second reactor R2 is flown by the airflow within the air recirculation loop to the third reactor R3 via the water/air/foam separator ST-01.

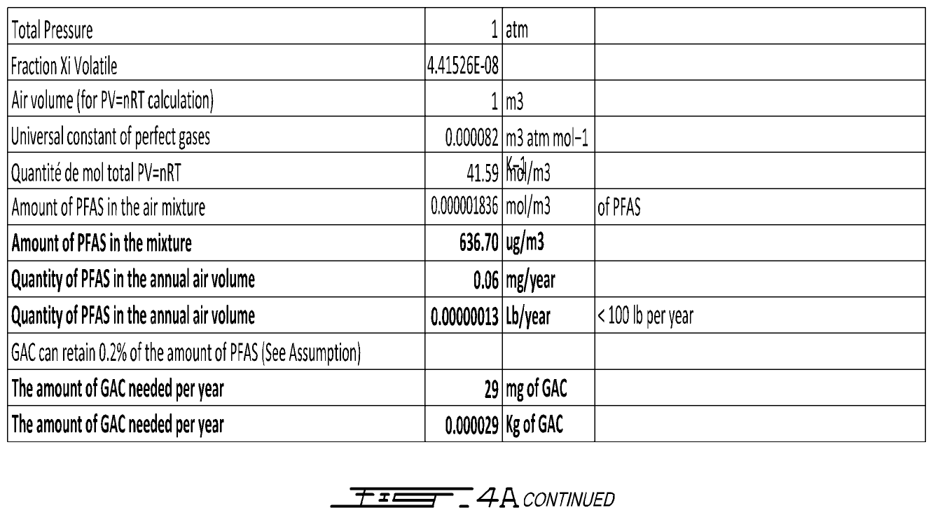

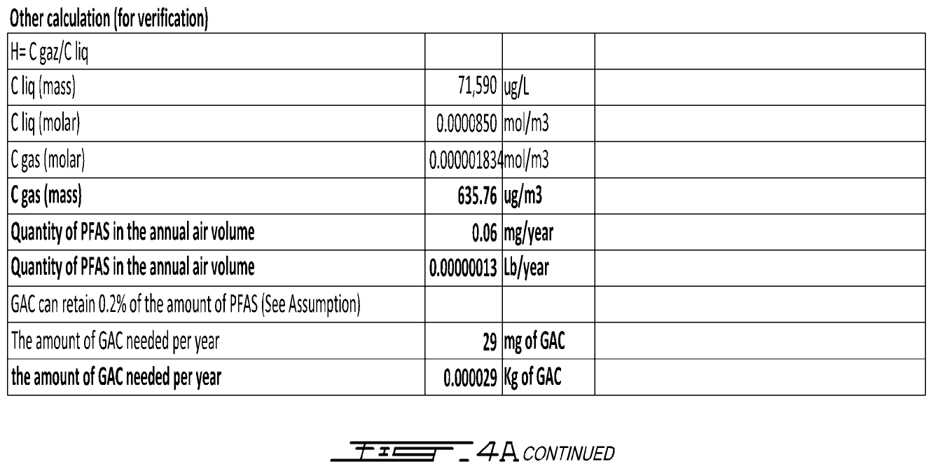

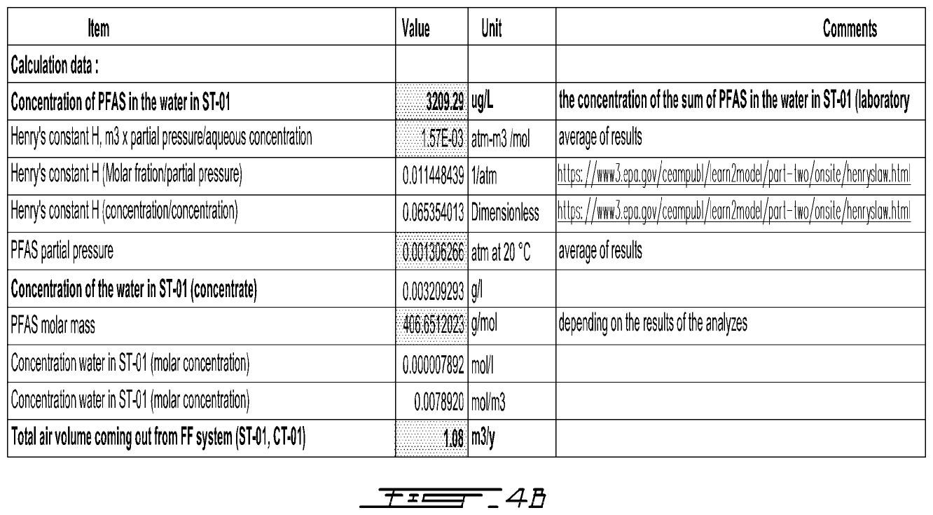

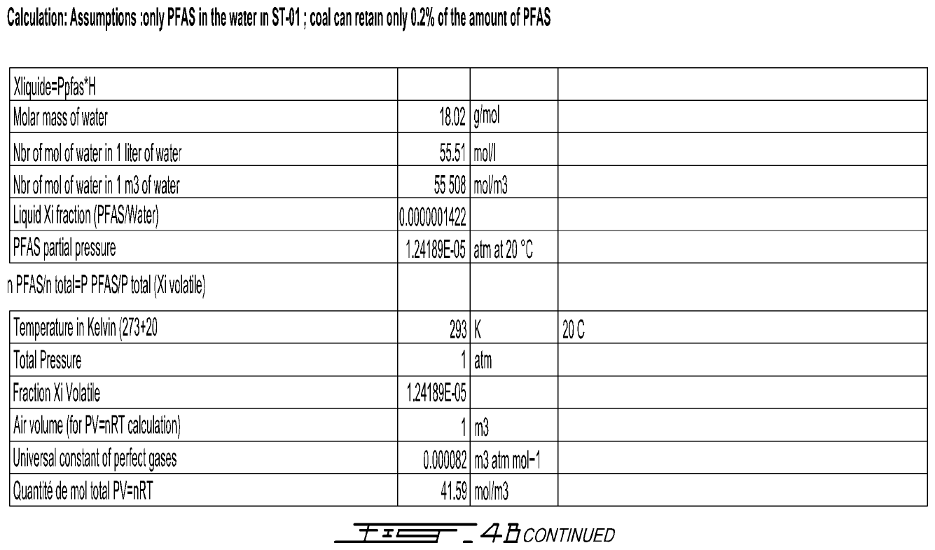

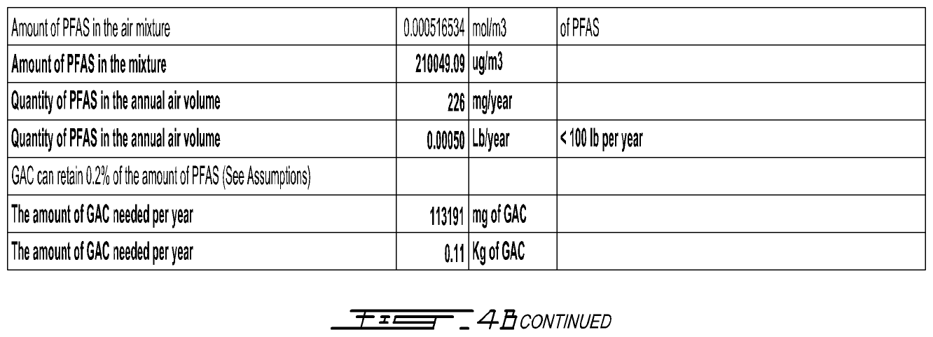

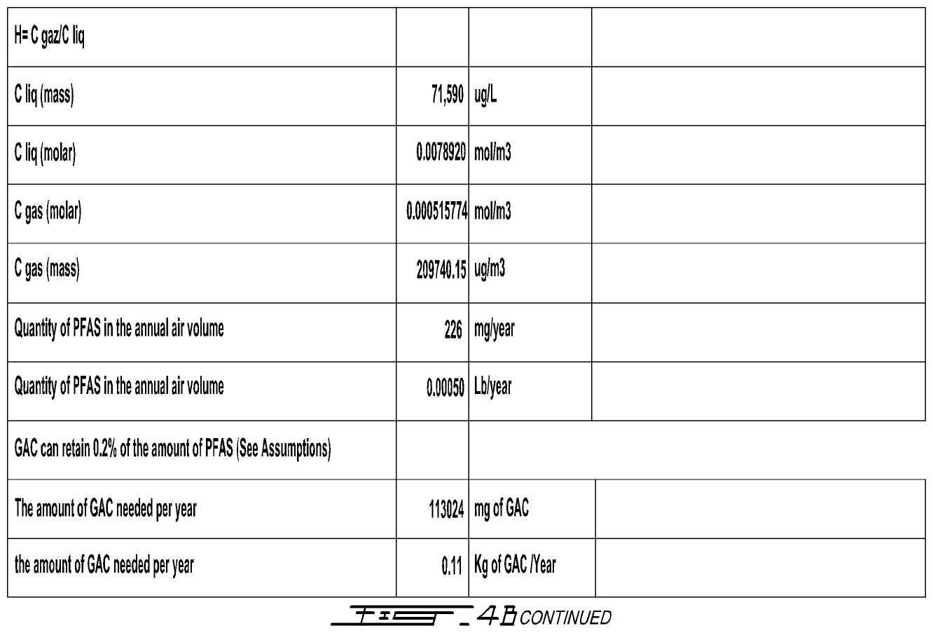

In the same time, in the second reactor R2, water pumped from the third reactor R3 undergoes foam fractionation while foam formed in the second reactor R2 is flown back to the water/air/foam separator ST-01, water is pumped out from the second reactor R2 to the compartments of the first reactor R1 for foam fractionation as described above, and repeat; the water charge of the foam, which may be retrieved by drainage and/or the foam being broken by mechanical shearing (see FS in FIG. 1) or by ultrasound (see US in FIG. 1) for example, thus being increasingly concentrated in the target molecules until a maximized concentration of the target molecules at the water outlet of the water/air/foam separator CT-01 to a concentrate harvesting tank, as the water/air/foam separator CT-01 collects the foam from the airflow in the air duct, from which the water/air/foam separator CT-01 separates water, which is pumped to the concentrate harvesting tank outside the system, while in the system the airflow continues its way to the diffusers of the reactors, where it separates, charges with foam over each reactor and recombines while charging with foam on its loop to the water/air/foam separator CT-01, and repeat, in the air recirculation loop. In the air recirculation loop, the airflow separates and travels up through each one of the compartments, and recombines while charging with foam from the compartments on its way to the water/air/foam separator CT-01, while water is constantly circulated in the system from the water feed inlet at R1 in the water recirculation loop from R3 to R2, and from R2 to R1 (see FIG. 3), while treated water is pumped out from the treated water outlet at R1, and while concentrate is pumped out from the water outlet of the water/air/foam separator CT-01 to the concentrate harvesting tank.

The foam may be broken using shear impellers or using sonification probes selectively positioned within the air recirculation loop where foam may accumulate (see FS and US in FIG. 1), such as in the air downstream part of water/air/foam separators ST-01 and CT-01 for example.

The foam generated and retrieved in the system, at the surface of the water inside each compartment, is channeled in the air recirculation loop of the system such that on the way of the foam in the airflow direction in the air recirculation loop, water trapped inside the foam is separated and returned to the reactors for foam fractionation simultaneously, all the compartments and all the water/air/foam separators processing water, air and foam, separately and simultaneously, in the water recirculation loop and the air recirculation loop within the system. The target modules charge of the water circulating within the system is thus treated in cascade, from the water inlet into the system to the treated water outlet out of the system, in the water recirculation loop within the system, decreasing from the raw water as it is being fed into the system to a target treated water at the treated water outlet of the system, and a corresponding concentrate at the concentrate output of the system.

The number of compartments in each reactor is selected according to a target residence time of the water for the target molecules removal according to the water flow rate in each reactor and depending on the physico-chemical characteristics and foaming capacity of the feed water. R1 is shown with four compartments; R2, fed with water separated from the foam coming out from R1 (by the water/air/foam separator ST-01 in FIG. 1) is shown with three compartments, and R3, receiving mainly water separated from foam evacuated from R2 and separated by the water/air/foam separator ST-01, is shown with one compartment. Also, depending on the physico-chemical characteristics and foaming capacity of the feed water, a foaming agent (surfactant) may be added in the water inlet to R1 or in the water inlet to the second, third, or fourth compartment to improve the foaming in R1, resulting in variable water amount directed to R2, which is typically between 8 to 50% of the feed water.

The compartments may comprise flow straighteners, positioned at selected heights in the water column inside the compartments relative to the air diffusers and to the top water surface of each compartment on height-adjustable supports. The height of each flow straightener may be selected in a range between about a few inches and a few tenths of inches, depending on the height of the water column in the compartment. Flow straighteners may comprise one element or stacked elements separated by a distance in a range between a few inches to a few tenths of inches, with a height selected in a range between about a few inches and a few tenths of inches, depending on the height of the water column in the compartment. Made in water corrosion resistant materials such as stainless, polyethylene, or PVC for example, they may be removable from the reactors through an access port, for cleaning purposes for example. Honeycomb-shaped tubes FS for example, as illustrated in FIG. 3A, or cylindrical or square for example, may be used in the compartments R1-A1 to R1-A4 of reactor R1 for example, as illustrated in FIG. 3B.

Flow straighteners were found to induce the air bubbles to circulate in a straight and laminar upward flow in the water column thereby preventing air bubbles charged with target molecules from returning to the bottom of the compartments and from being dragged in the water flow from there. The shape, size, position, and number of flow straightener elements may be selected depending on operational conditions and on the physicochemical properties of the raw water fed into the system for treatment, which may impact the dynamic of the water flow within the system and of the air bubbles flow inside the compartments; the water surface tension for example may impact the dynamic of air and liquid flow. The shape, size, position, and number of flow straightener elements may also be selected according to a target air bubble flowrate in view of a target performance of the system, for example depending on the amount and nature of suspended solids in the water.

The reactors and compartments thereof may have a square or rectangular shape.

FIG. 2 shows the compartments topped by conical-shaped collectors that draw the foam in optimized hydraulic dynamic conditions within the air recirculation loop, minimizing hydraulic turbulences upon evacuation of the foam from the top water surface in each compartment to minimize collapse of the foam in the airflow and optimize drainage of water from the foam as the foam is collected from the compartments in the air recirculation loop.

The air diffusers may be aeration discs, porous stones, porous tubes, or perforated membranes for example. The size of the perforations of perforated elastic membranes tubes may be controlled by controlling the pressure within the perforated elastic membranes tubes by controlling the airflow rate, allowing to adjust the pressure within the perforated elastic membranes tubes so as to disrupt any solid accumulation obstructing the perforations for example; the tubes may be dismounted for cleaning or replacement.

The system may be tuned to the physico-chemical characteristics and foaming capacity of the raw water fed into the system by adjusting the foaming conditions in R1 and R2, using surfactants at the raw water inlet of the system and/or at the water inlets of the compartments of R1 and/or by modifying the airflow rate and/or the height of the water column in each compartment until target foaming conditions, using controllable feeding water pumps and evacuating water pumps at the system's raw water inlet and at the system's treated water outlet respectively. Foaming conditions may be monitored by determining the amount of foam in the compartments, measuring the top foam electrical conductivity at the top water surface of each compartment, and the water content of the foam, for example; sensors may be used for real-time foam monitoring (see M in FIG. 1); for example, high-speed cameras coupled with artificial intelligence may be used to scan and monitor physical characteristics of the foam including for example the air bubbles size and shape, flowing speed, etc. Air flow meters may be used to control the airflow to prevent the foam from expanding too quickly, bursting and collapsing on itself in the compartments. The water levels are monitored to prevent air breezing through in and out between the system and the outside environment, any air breathers comprises filters such as granular activated carbon (GAC) for example.

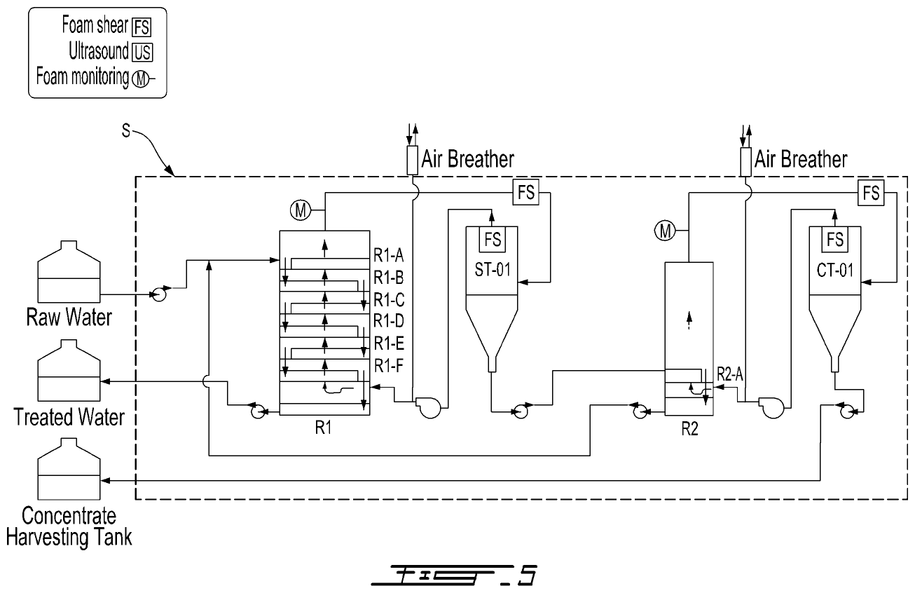

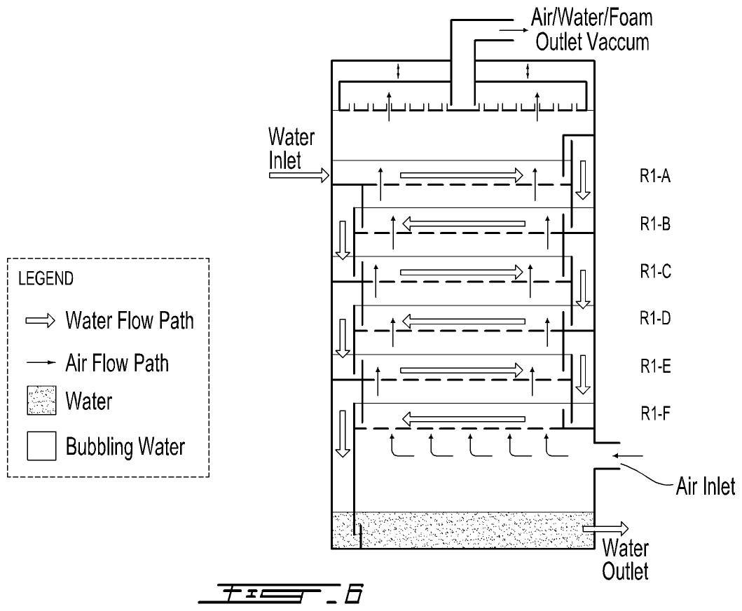

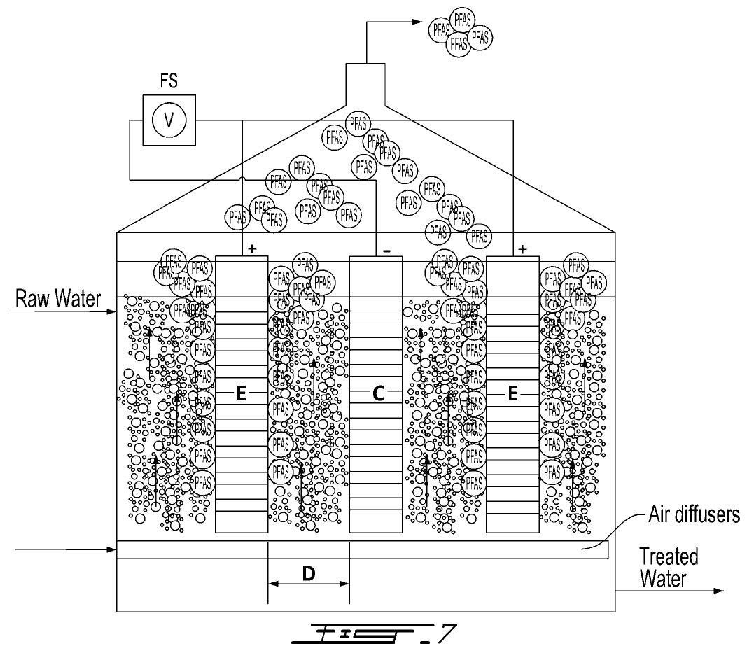

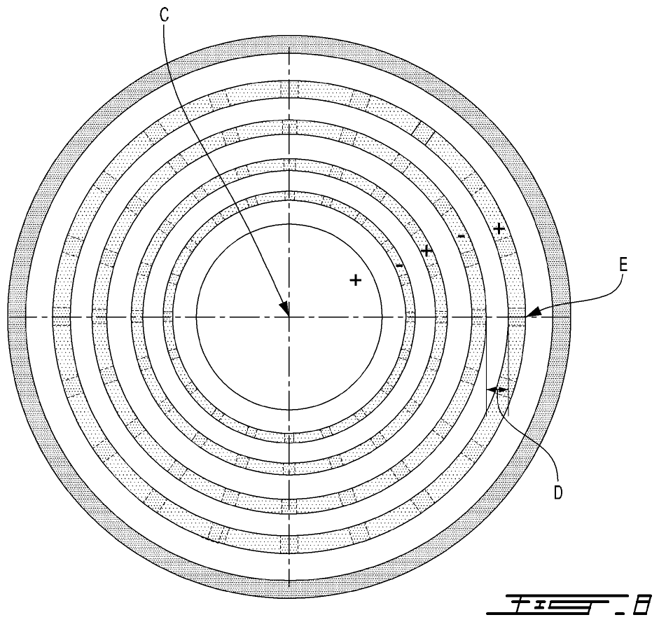

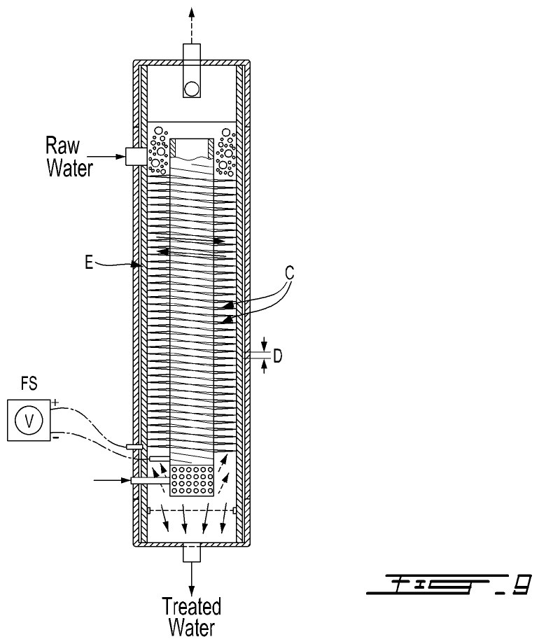

In case of a 40 gallons per minute (gpm) PFAS-concentrated water of concentration of about 30μg/L PFAS containing only PFAS (no other volatile compounds), results of simulations for the water as treated and output by the system with breathers in the air recirculation loop via the water/air/foam separator ST-01, show a PFAS concentration of the concentrate output by the system to the harvesting concentrate tank of about 3200 qug/L, carbon filters retaining capacity of about 0.2% on a weight basis of the PFAS charge in the air breezing through (see FIGS. 4A and 4B).

The treatment of the target molecules-concentrated water is performed in a cascade in the water recirculation loop to obtain decreasingly target molecules-charged water and increasingly target molecules-charged concentrate, as foam is collected from the top water surface in each fractionation compartment of each reactor by the air circulated in the air recirculation loop within the system.

In another embodiment as illustrated for example in FIGS. 5-7, the compartments are stacked in the reactors and water circulates from the top to the bottom compartment as air is circulated through the compartments from the bottom to the top compartment.

In each foam fractionation compartment, foam is generated at the top surface of the water, the foam formed in each compartment passing in the air flow to the next compartment in the air flow direction in the air recirculation loop as guided by the air duct, until the upmost compartment. The succession of compartments corresponds to successive water treatment as described hereinabove relation to FIGS. 1-3 hereinabove, with water circulating in a direction opposite from a direction of the airflow. The number of compartments is selected according to a target treatment efficiency; treatment efficiency increasing with the number of compartments until physical limitations such as the height clearance available in the place, such as a building or a container for example, where the reactor is placed, the pressure loss created by the water column and the restriction of air passing through the air flow holes in each compartment.

In FIGS. 5-7 , a first fractionation reactor R1, a second fractionation reactor R2, and water/air/foam separators ST-01 and CT-01 are shown, connected in the air recirculation loop by the air duct. The water circulates from top to bottom in the first fractionation reactor R1, i. e. successively from the top fractionation compartment R1-A to the bottom fractionation compartment R1-F, water being passed through by air in each fractionation compartment and overflowing successively down to lower fractionation compartments as air and foam from each fractionation compartment is blown over to the upper fractionation compartment to the air duct at the top of the first fractionation reactor R1 (see downward pointing arrows from R1-A to R1-B, to R1-C, to R1-D, to R1-E and to R1-F, and upward point arrows in reverse direction in FIGS. 5-7) .

In this stacked configuration of the fractionation compartments, the level of target molecules contamination in the water decreases from the top down to the bottom fractionation compartment in each fractionation reactor, air circulating through the fractionation compartments of each fractionation reactor from the bottom to the top of the reactor, foam being generated and surfacing to the water top surface in each fractionation compartment being drawn with the airflow of the air recirculation loop to the next fractionation compartment above until the top of each fractionation reactor. The successively stacked fractionation compartments perform the successive water treatments described hereinabove in relation to FIGS. 1-3 , with water and air circulating in reverse directions in the circulation loops.

Target molecules may be attracted to surfaces of electrodes immersed inside the fractionation compartments, the ascending air bubbles gathering the particules as they sweep over these surfaces and conveying them up into the foam at the water surface of the fractionation compartments. Such electromagnetic capture may be used in any compartments of the foam fractionation reactors of the system, or selectively in a last stage of foam fractionation as a polishing step for removal of remaining target molecules, in case of amounts of high solubility in water such as short-chain PFAS in the water to be treated by the system for example.

The compartment as illustrated for example in FIGS. 7 and 8, made in a non-conductive material, comprises electrodes connected to an electric power supply S, shown as cylinders a positive or negative electrode C is shown centrally positioned between alternatively positive and negative concentric electrodes E, which may be perforated for optimized water flow therebetween. The electrodes are made in a material selected depending on the physicochemical properties of the water being treated by the system; for example, electrodes that resist corrosion, in stainless, or graphite for example, may be selected depending on the water pH; otherwise aluminum and copper electrodes for example may be used. Distanced and vertically extending electrodes provides narrow channels that force a linear and laminar upward flow of the air bubbles ascending the water column in the compartment; the electrodes may be used for eliminating turbulence which may cause air bubbles to which target molecules are attached to rotate in circles and be dragged downward the water column with target molecules attached thereto.

The alternatively positive and negative electrodes E are separated from one another by a distance D selected for generating an electromagnetic field below a threshold maximum power of electrolysis of water, to prevent generation of undesirable gases, such as hydrogen and its flammable properties and oxygen leading to explosive conditions inside the air recirculation loop of the system.

In the example of PFAS molecules, the ratio of the power density to the electrodes surface may be selected below the oxidation of long to short chains PFAS considering longer-chain PFAS may be more effectively removed by foam fractionation.

FIG. 9 shows either the positive or the negative electrodes E helically wrapped around the central electrode C, thereby optimizing the contact surface with the target molecules.

All compartments of all reactors of the system operate simultaneously while air and water are circulated within the system in recirculation loops, from the production of foam through water columns in fractionation compartments to separation of the produced foam from the air and return of the air to the reactors for reuse, using air extraction/injection blowers for example, and from water and return of the water to the reactors for further foam fractionation, the water/air/foam separator CT-01 receiving the airflow containing foam collected from the reactors, the foam being separated from the airflow, and the airflow being pushed back to the diffusers of the reactors, in the air recirculation loop and the water recirculation loop within the system, the system outputting resulting target molecules concentrate separated from treated water.

The scope of the claims should not be limited by the embodiments set forth in the examples but should be given the broadest interpretation consistent with the description as a whole.

1. A foam fractionation system, comprising:
a raw water inlet;
a treated water outlet;
a concentrate outlet;
air ducts configured into an air recirculation loop and a water recirculation loop, a flow direction in the air recirculation loop being opposite a flow direction in the water recirculation loop; and
within the air and water recirculation loops:
a water/air/foam separator;
at least one fractionation reactor comprising at least two compartments located successively in the flow direction in the water recirculation loop from the first compartment of a first one of the at least one reactor in the water recirculation loop from the first reactor, each compartment comprising a top water/air/foam separator and bottom air diffusers;
wherein, raw water containing target molecules entering the system through the raw water inlet of the system enters the water recirculation loop at an inlet of the first compartment, flows in the flow direction in the water recirculation loop through the successive compartments while said bottom air diffusers inject air in the water in each compartment individually, producing in a water column of each compartment air bubbles that attach the target molecules in the water column as the air bubbles ascend to a top water surface in each compartment and generate a target molecules-charged foam at the top water surface of each compartment, water separating from the target molecules-charged foam in the top water/air/foam separator of each compartment returning to the compartment while the target molecules-charged foam is drawn in the air recirculation loop to the water/air/foam separator;
the water/air/foam separator separating water pumped out back to the first fractionation reactor, a target molecules concentrate pumped out of the water recirculation loop at a concentrate outlet of the water/air/foam separator to the concentrate outlet of the system, and air pumped to the bottom air diffusers; and water being pumped out of the water recirculation loop of the system at an outlet of a last compartment of the first reactor to the treated water outlet of the system.

2. The system of claim 1, wherein the raw water entering the water recirculation loop of the system at the inlet of the first compartment of the first reactor of the system comprises at least ones of: PFAs; microbial electrochemical systems, colloids, microplastics, and hydrophobic/oleophilic molecules.

3. The system of claim 1, wherein relative positions of water inlets and water outlets of each compartment and of the air diffusers in each compartment are selected according to at least one of a target residence time of water within each compartment as the water flows from the respective water inlet and outlet thereof; and a minimized water amount in the target molecules-charged foam at the top water surface of each compartment.

4. The system of claim 1, wherein the bottom air diffusers are positioned to maximize circulation of air up the water column in each compartment and prevent producing air bubbles with attached target molecules in the water flow direction.

5. The system of claim 1, wherein relative positions of water inlets, water outlets and the bottom air diffusers in each compartment are selected according to at least one of a target residence time of water of within each compartment from the respective water inlet and outlet thereof; a target water amount in the target molecules-charged foam at the top water surface of each compartment; a target air circulation through the water column in each compartment; and a minimized production of air bubbles in the water flow direction between successive compartments of the reactor.

6. The system of claim 1, wherein each compartment comprises, successively relative to the top water surface, in the water column inside the compartment, a water inlet, the bottom air diffusers, and a water outlet.

7. The system of claim 1, wherein said ducts comprise air ducts guiding air in the air recirculation loop, the air separating and passing through each compartment of each reactor, and recombining charged with the target molecules-charged foam of each compartment on a way to the water/air/foam separator, while raw water constantly enters the water recirculation loop of the system at the first compartment of the first reactor, the water recirculation loop passes through all reactors of the system in the water flow direction, the treated water being pumped out of the water recirculation loop of the system from the last compartment of the first reactor, and the concentrate is pumped out of the water recirculation loop of the system from the water/air/foam separator.

8. The system of claim 1, wherein said water/air/foam separator comprises at least one of shear impellers and sonification probes.

9. The system of claim 1, wherein said top water/air/foam separator comprises at least one of shear impellers and sonification probes.

10. The system of claim 1, wherein at one least compartment comprises flow straighteners.

11. The system of claim 1, wherein at least one compartment comprises flow straighteners positioned in the water column of the compartment at selected heights relative to the bottom air diffusers and to the top water surface.

12. The system of claim 1, wherein the compartments are stacked in each reactor, and the water flow direction is from a top one of the compartment to a bottom one of the compartments, air circulating through the bottom compartment to the top compartment.

13. The system of claim 1, wherein at least one compartment is made in a non-conductive material and comprises at least one set of electrodes extending along a height of the water column in the compartment and connected to an electric power supply, and comprising one of: a positive and a negative electrode centered between alternatively positive and negative electrodes.

14. A foam fractionation method, comprising:
forming an air recirculation loop with an air flow direction, and a water recirculation loop with a water flow direction, the air flow direction being opposite the water flow direction; and
within the air and water recirculation loops:
connecting a water/air/foam separator;
at least one fractionation reactor comprising at least two compartments located successively in the flow direction in the water recirculation loop from the first compartment of a first one of the at least one reactor in the water recirculation loop from the first reactor, each compartment comprising a top water/air/foam separator and bottom air diffusers;
entering raw water into the water recirculation loop at a first compartment of a first reactor of the at least one fractionation reactor, injecting air of the air recirculation loop through the bottom air diffusers in a water column of each compartment individually, thereby producing in each compartment air bubbles that attach target molecules in the water column in each compartment as the air bubbles ascend to a top water surface in each compartment and generate a target molecules-charged foam at the top water surface of each compartment;
in the top water/air/foam separator of each compartment: separating water from the target molecules-charged foam in the top water/air/foam separator of each compartment, for return by gravity in the compartment, from target molecules-charged foam, to be drawn to the water/air/foam separator by the air recirculation loop;
at the water/air/foam separator: separating water pumped out back to the first fractionation reactor, from a target molecules concentrate pumped out of the water recirculation loop at a concentrate outlet of the water/air/foam separator, and from air pumped to the bottom air diffusers; and
pumping treated water out of the water recirculation loop at an outlet of a last compartment of the first reactor.

15. The foam fractionation method of claim 14, comprising stacking the compartments in each reactor, with the water flow direction from a top one of the compartment to a bottom one of the compartments, and the air flow direction from the bottom compartment to the top compartment.

16. The foam fractionation method of claim 14, comprising providing at least one compartment made in a non-conductive material and comprising at least one set of electrodes extending along a height of the water column of the compartment and connected to an electric power supply and comprising one of:
a positive and a negative electrode, centered between alternatively positive and negative electrodes.

17. The foam fractionation method of claim 14, comprising positioning flow straighteners at selected heights relative to the bottom air diffusers and to the top water surface in at least one compartment.

18. The foam fractionation method of claim 14, comprising positioning at least one of shear impellers and sonification probes within the air flow recirculation loop.

19. The foam fractionation method of claim 14, comprising selectively positioning, successively relative to the top water surface, in the water column inside each compartment, a water inlet, the bottom air diffusers, and a water outlet.

20. The foam fractionation method of claim 14, wherein the target molecules comprise at least ones of: PFAs; microbial electrochemical systems, colloids, microplastics, and hydrophobic/oleophilic molecules.
